(19) United States
(12) Patent Application Publication
(10) Pub. No.: US 2009/0311914 A1
(43) Pub. Date: Dec. 17, 2009

(54) SENSING FAUCET

(76) Inventor: Chen Weigen, Shanghai (CN)

Correspondence Address: LADAS & PARRY LLP, 224 SOUTH MICHIGAN AVENUE, SUITE 1600, CHICAGO, IL, 60604, US

(21) Appl. No.: 12/297,465

(22) PCT Filed: Apr. 19, 2007
(86) PCT No.: PCT/IB2007/001022

§ 371 Date: Feb. 20, 2009

(30) Foreign Application Priority Data
Apr. 20, 2006 (CN) CN200620041184.7

(51) Int. Cl. H01R 24/00; F16K 31/02

(52) U.S. Cl. 439/660; 251/129.04

(57) ABSTRACT

A sensing faucet used in sanitary wares is provided. The sensing faucet has a sensor and a battery compartment fixed onto the faucet shell. A valve body control system has valve control components fixed onto the valve body. There is a plug seat in the faucet shell, and a corresponding plug is installed on the valve body. During installation, the faucet shell is aligned with the valve body and the plug can be seated within the plug seat. The plug is provided with a spring-loaded electrical pin to make contact with an electrical panel in the plug seat.

### TECHNICAL FIELD

A sensing faucet installation structure used in bathrooms.

### BACKGROUND TECHNOLOGY

Publicly known sensing faucet installation structures basically consist of two types. One type has the electric control box and battery compartment directly installed onto the valve body, and a faucet shell is used to cover them. Such a structure is largely restricted by the space within the faucet shell. For the sake of disassembling the battery, the battery compartment should be installed at a position that can be directly disassembled. If the faucet is limited to a small diameter of tens of millimeters, it is very hard to design a suitable structure. The other type has the electric control box and battery compartment installed onto the faucet shell, which moves together with the electric control box and battery compartment during installation and disassembling. However, with this type, there should be a plug connected to the solenoid valve on the valve body. The plug should be disconnected during disassembling. Such a structure may not be convenient for installation and disassembling.

### INVENTION CONTENT

In order to overcome the disadvantages of the existing sensing faucet installation structure, the present invention provides a new type of faucet structure, which not only is less demanding to the faucet's outer look, but also provides convenient disassembling. At the same time, stable function and service life can be guaranteed.

### SUMMARY OF THE INVENTION

A preferred embodiment of the present invention may provide the electric control box and battery compartment installed onto the faucet shell. A connector is installed at the lower part of the battery compartment, and a plug seat is installed onto the faucet valve body. The plug preferably has 2 pins with internal springs, and the pins are installed in a rubber stopper. The tip of the pins can withdraw when pressed so that vertical tolerance can be removed. When installing the faucet shell, 2 guide pins on the valve body engage grooves on the faucet shell so that the plug can be lined up and directed into aligned engagement with the plug seat. The pins directly press an electric panel inside the plug seat; at the same time, there are circular tendons around a rubber stopper to form a seal. When disassembling the faucet shell, the faucet shell can be directly pulled out and the plug automatically detaches the plug seat. This arrangement is very convenient.

### BRIEF DESCRIPTION OF THE DRAWING FIGURES

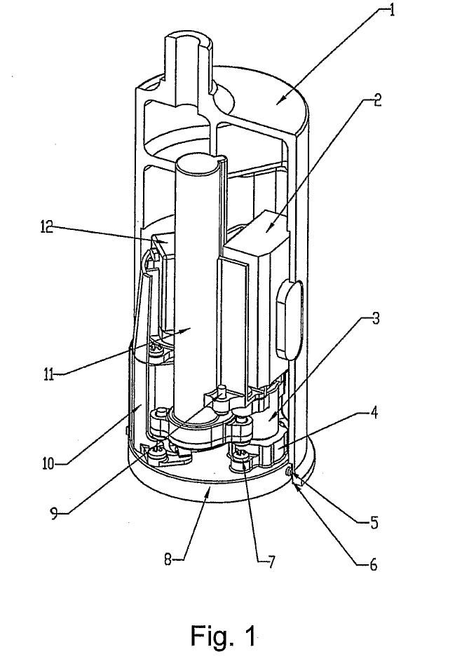

Drawing FIG. 1 is an illustration of the assembled sensing faucet, with a cut-out view of the faucet shell.

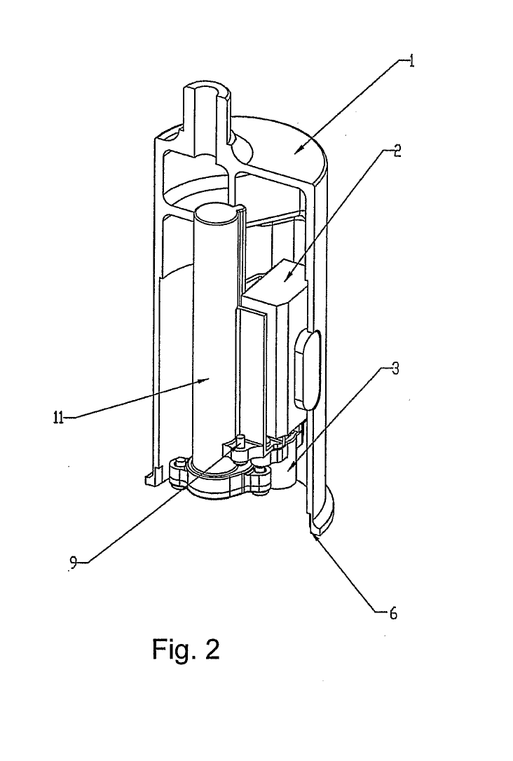

Drawing FIG. 2 is a cut-out illustration of the faucet shell components.

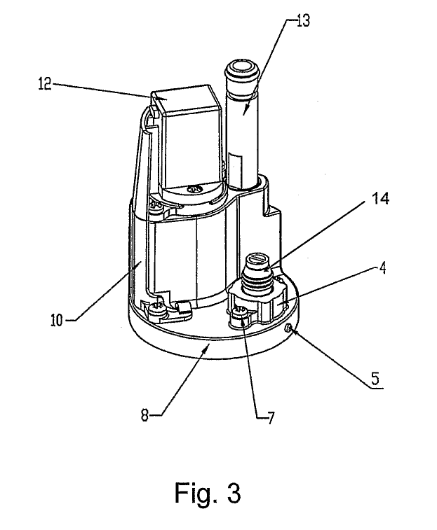

Drawing FIG. 3 is an illustration of the valve body assembly.

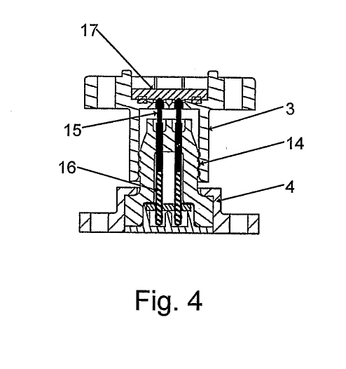

Drawing FIG. 4 is a cross-sectional illustration of the plug.

In the drawings, 1. faucet shell; 2. electric control box; 3. plug seat; 4. plug; 5. guide pin; 6. positioning groove; 7. mounting screw; 8. valve body; 9. mounting screw; 10. wire protection cover; 11. battery compartment assembly; 12. solenoid valve; 13. outlet pipe; 14. circular tendons; 15. electrical pins; 16. springs; 17. electric panel

### DETAILED DESCRIPTION OF THE PREFERRED EMBODIMENTS

In FIG. 1, the faucet shell 1 is shown mounted on the valve body 8. Proper alignment of the faucet shell 1 and the valve body 8 is provided by sliding engagement of the guide pin 5 into the positioning groove 6. The plug 4 is inserted into the plug seat 3 in this installed position, to provide an electrical connection therebetween. The electrical connection between the plug 4 and plug seat 3 allows power from batteries within the battery compartment assembly 11 to operate the solenoid valve 12 when power is activated by electric control box 2 which switches power on and off. The electric control box 2 may also include a sensor, the activation and deactivation of which switches the power on and off. The sensor may preferably be a motion or proximity sensor.

FIG. 2 depicts a cut-out view of only the faucet shell 1 portion, with installed battery compartment assembly 11, electric control box 2, and plug seat 3. Mounting screws 9 may be utilized to removably install these components within the faucet shell 1.

FIG. 3 depicts only the valve body 8 portion, with installed solenoid valve 12 and plug 4. The solenoid valve 12 and plug 4 are electrically connected. A wire protection cover 10 may be provided to protect the electrical connection. Mounting screws 7 may be provided to removably install these components onto the valve body 8.

A fluid inlet (not shown) may be fluidly connected to the valve body 8. The solenoid valve 12 opens and closes a valve, permitting or restricting fluid flow into and through outlet pipe 13.

FIG. 4 is a cross-sectional view of the plug 4 and plug seat 3. The plug 4 has at least one electric pin 15 which is spring loaded by a spring 16 to allow movement in the longitudinal axial direction. The spring loaded electric pin 15 allows for electrical contact to be maintained with the electric panel 17 in the plug seat 3 when the plug 4 is inserted into the plug seat 3.

Although the preferred embodiment shows the plug 4 being mounted on the valve body 8, and the plug seat 3 being mounted on the faucet shell 1, the relative positions of the plug 4 and plug seat 3 may be switched.

FIGS. 3 and 4 depict the plug 4 as having optional circular tendons 14 that serve as a seal member between the plug 4 and plug seat 3. The circular tendons may be made of rubber or a similar sealing material. The circular tendons 14 may be formed on either or both of the plug 4 and plug seat 3. Also, while the preferred embodiment shows the electric pin(s) 15 in the plug 4, and the electric panel(s) 17 in the plug seat 3, the electric pin(s) 15 and the electric panel(s) 17 may be formed on either the plug 4 or plug seat 3.

Although the present invention has been shown and described herein by way of preferred embodiments, it is understood that the invention may be modified without departing from the spirit and scope of the invention as defined in the following claims.

1. An electrical connection comprising:
a plug;
a plug seat;
at least one electrical panel; and
at least one spring-loaded electrical pin;
wherein the at least one electrical panel is disposed on one of the plug or the plug seat, and the at least one electrical pin is disposed on the other of the plug or the plug seat unoccupied by the at least one electrical panel;
wherein the plug is shaped and configured to be removably received within the plug seat; and
with the plug in a plug receiving position within the plug seat, a tip of the at least one electrical pin is disposed to be in contact with the at least one electrical panel.

2. The electrical connection of claim 1, wherein two spring-loaded electrical pins are provided in the plug.

3. The electrical connection of claim 1, wherein at least one of the plug and plug seat is provided with a seal member disposed between the plug and the plug seat with the plug in the plug receiving position within the plug seat.

4. The electrical connection of claim 3, wherein the seal member is provided on the plug.

5. The electrical connection of claim 3, wherein the seal member is a circular tendon.

6. The electrical connection of claim 1, wherein the at least one electrical panel is disposed on the plug seat, and the at least one spring-loaded electrical pin is disposed on the plug.

7. The electrical connection of claim 1, wherein the at least one electrical pin is movable along a longitudinal axis of the at least one electrical pin.

8. A sensing faucet comprising:
a faucet shell having an electric control box;
a valve body having a solenoid valve; and
first and second electrical connection components comprising a plug and a plug seat;
wherein the first electrical connection component is provided on the faucet shell, and the second electrical connection component is provided on the valve body;
at least one electrical panel; and
at least one spring-loaded electrical pin;
wherein the at least one electrical panel is disposed on one of the plug or the plug seat, and the at least one electrical pin is disposed on the other of the plug or the plug seat unoccupied by the at least one electrical panel;
wherein the plug is shaped and configured to be removably received within the plug seat; and
with the plug in a plug receiving position within the plug seat, a tip of the at least one electrical pin is disposed to be in contact with the at least one electrical panel.

9. The sensing faucet of claim 8, wherein two spring-loaded electrical pins are provided in the plug.

10. The sensing faucet of claim 8, wherein at least one of the plug and plug seat is provided with a seal member disposed between the plug and the plug seat with the plug in the plug receiving position within the plug seat.

11. The sensing faucet of claim 10, wherein the seal member is provided on the plug.

12. The sensing faucet of claim 10, wherein the seal member is a circular tendon.

13. The sensing faucet of claim 8, wherein the at least one electrical panel is disposed on the plug seat, and the at least one spring-loaded electrical pin is disposed on the plug.

14. The sensing faucet of claim 8, further comprising a battery compartment in the faucet shell.

15. The sensing faucet of claim 8, wherein said first electrical connection component is said plug seat, and said second electrical connection component is said plug.

16. The sensing faucet of claim 8, further comprising a guide pin and a positioning groove which slidingly engage each other to provide alignment and positioning of the faucet shell on the valve body, wherein the guide pin is disposed on one of the faucet shell or the valve body, and the positioning groove is disposed on the other of the faucet shell or the valve body unoccupied by the guide pin.

17. The sensing faucet of claim 8, wherein the electric control box comprises a motion sensor.

18. The sensing faucet of claim 8, wherein the electric control box comprises a proximity sensor.

19. The sensing faucet of claim 8, wherein the at least one electrical pin is movable along a longitudinal axis of the at least one electrical pin.
